(19) United States
(12) Patent Application Publication
(10) Pub. No.: US 2010/0208384 A1
(43) Pub. Date: Aug. 19, 2010

(54) Multi-head array hard drive

(76) Inventor: Don Tran, El Monte, CA (US)

Correspondence Address: LAW OFFICES OF CLEMENT CHENG, 17220 NEWHOPE STREET #127, FOUNTAIN VALLEY, CA, 92708, US

(21) Appl. No.: 12/378,665

(22) Filed: Feb. 18, 2009

(51) Int. Cl. G11B 21/02

(52) U.S. Cl. 360/75

(57) ABSTRACT

A multiple head array hard drive comprises a multiple fixed head array. The multiple fixed head array has multiple rows of read write heads. The read write heads of a row are fixed relative to each other on the multiple fixed head array. The heads of the multiple fixed head array are arranged in a staggered pattern. The staggered pattern can be a zigzag pattern or a diagonal pattern. The disk has data encoded on the disk. The multiple fixed head array is positioned to read data over a surface of the disk. The disc rotates relative to the multiple fixed head array.

### DISCUSSION OF RELATED ART

Currently, PCs have a speed bottleneck. Throughout the 1980s, the CPU (Central Processor Unit) speeds for ×486 for PC's and laptops increased from 33 Hz, then 66 Hz, then 120 Hz, and onward. The speeds of the CPU kept increasing, doubling every 6 months to one year, in accordance with Moore's Law. Moore's Law states that CPU speeds will double every year to two years. However, two problems now exist. First, the circuits may have begun to reach a physical limit of how small they can be. This has created a second problem of how many circuits can be packed on a waffle. Therefore, the CPU architecture has been changed so that different architecture is now being used instead of simply decreasing the size of the circuits. For example, numerous cores are installed in each CPU providing multitasking capabilities. Additionally, processors have moved from 32-bit to 64-bit architecture. Based on size limitations and being unable to further fit more circuits on a CPU, the Hertz Cycles may have reached their maximum top speed limits.

Over the years, CPU speeds have doubled or exponentially increased, but the actual real-time application such as operating systems and end-user software speeds have not increased at the same double or exponential rates of the processors. While other PC/Laptop architecture speeds and capacity have increased such as memory capacity, clock and bus speeds, hard drive speeds have become a bottleneck and have not kept up or increased their speeds.

A variety of factors limit hard drive speed. There are two main problems. The first main problem is that rotational delay is one of the three delays associated with reading or writing data on a computer's disk drive, and somewhat similar for CD or DVD drives. The other delays are seek time and transfer time, and their sum is access time. The term rotational delay applies to rotating storage devices, such as a hard disk or floppy disk drive and to the older drum memory systems. Rotational delay is the time required for the addressed area of the disk or drum to rotate into a position where it is accessible by the read/write head.

Maximum rotational delay is the time it takes to do a full rotation, as the relevant part of the disk may have just passed the head when the request arrived. Most rotating storage devices rotate at a constant angular rate. The maximum rotational delay is simply the reciprocal of the rotational speed (appropriately scaled). In 2001, 7200 rpm was typical for a hard disk drive, so in 2001 its maximum rotational delay was 60/7200s, or about 8 ms. Hence, the general term 8 ms seek time as a rating of HD speeds, the lower the number the better.

Seek time currently ranges from just under 2 ms for high-end server drives to 15 ms for miniature drives, with the most common desktop type typically being around 9 ms. There have not been any significant improvements in this speed for some years. Some early PC drives used a worm gear to move the heads, and as a result had access times as slow as 80-120 ms. However, this was quickly improved by voice-coil type actuation in the late 1980s, reducing access times to around 20 ms.

The data transfer rate as of 2008 at the inner zone ranges from 45 MB/s to 3.0 GB/s, while the transfer rate at the outer zone ranges from 74.0 MB/s to 111.4 MB/s. In contrast, the first PC drives could manage only around 40 KB/s. The burst transfer rate as of 2008 reaches a maximum drive speed of up to 80 MB/s for eSATA, 35 MB/s for FireWire 400, and 30 MB/s average for USB 2.0. The interface transfer rate as of 2008 reaches a maximum bus speed up to 1.5 Gbits/s for eSATA, up to 400 Mbits/s for FireWire 400, and up to 480 Mbits/s for USB 2.0.

### SUMMARY OF THE INVENTION

The present configuration of the hard drive when seen from the top view provides multiple fixed heads for all platters. Current hard drive access function is sequential or linear which is only one data at a time by the singular head per platter. The present configuration seeks to reduce rotational delay factor. The multi-head array hard drive is non-sequential and multi-read/write. The multi-head array hard drive multitasks since it has multiple heads per platter not cover the entire sector with heads which cover all of any single track or cylinder for the purpose of reading or writing. Therefore, the array can read all data per track/cylinder across all sections of a sector at the same time. This eliminates the delay of from waiting for a swing-arm head to arrive at the correct position and remain at the correct position to pick up the next needed data.

Currently, the fastest enterprise grade hard drives spin at 10,000 or 15,000 rpm, and can achieve sequential media transfer speeds above 1.6 Gbit/s and a sustained transfer rate up to 125 MBytes/second. Drives running at 10,000 or 15,000 rpm use smaller platters because of air drag, and therefore generally have a lower capacity than the highest capacity desktop drives. As of 2008, most commercial drives for personal use, SOHO (Small Office Home Office) or SMB's (Small Medium Business's), are usually IDE, SATA, or eSATA drives that spin at 7200 rpm with 16 MB or 32 MB Buffers.

The present invention uses multiple sets of array to deal with rotational delay. Four different embodiments can be envisioned. The first embodiment involves a single row of Multiple-Fixed Heads (RMFH) per platter that covers all sectors per track/cylinder. The second embodiment has only two rows of Multiple-Fixed Heads (RMFH) per platter that covers all sectors per track/cylinder. The second RMFH is mounted exactly 180 degrees opposite of the first RMFH. The effect and result is an enhanced seek and transfer rate at double the RPM. This effectively turns the 7200 rpm used in this example into a 14,400 rpm drive.

The first and second embodiment operate by the first array or RMFH reading the first data. However, if the second set of data that it might be required to seek and transfer moves past the first RMFH, the second RMFH will pick it up. This effectively cuts the time of revolution in half, or makes the drive's seek/transfer time twice as fast.

The third embodiment has only three rows of Multiple-Fixed Heads (RMFH) per platter that covers all sectors per track/cylinder. The third RMFH is mounted exactly 120 degrees apart from the first and second RMFHs, most effectively at ⅓ interval on the platter. The effect and result is an enhanced seek and transfer rate at triple the RPM. The third embodiment operates by the first RMFH reading the first set of data, and the second RMFH reading the second set of data. The next data required will be read by the third RMHF. This effectively cuts the time of revolution down to one-third the time required, or makes the drive's seek/transfer time three times as fast.

The fourth embodiment has only four rows of Multiple-Fixed Heads (RMFH) per platter that covers all sectors per track/cylinder. The fourth RMFH is mounted exactly 90 degrees apart from the first, second and third RMFHs, most effectively at ¼ interval on the platter. The effect and result is an enhanced seek and transfer rate at quadruple the RPM. The fourth embodiment operates by the first RMFH reading the first set of data, the second RMFH reading the second set of data, and the third RMHF reading the third set of data. The next data required will be read by the fourth RMHF. This effectively cuts the time of revolution down to one-fourth the time required, or makes the drive's seek/transfer time four times as fast.

An optional fifth embodiment which is a potential possibility, would have five RMHF, however it is not preferred because of potentially diminishing returns.

The present invention therefore does not rely on a single swingarm, and replaces the single swingarm with a multihead array also called the RMFH or the array. Instead of increasing RPM speed, which is not possible in compact HD configurations, extra RMFHs are added at strategic locations on the drive per platter. In respect to the first RMFH, the second is 180 degrees apart, the third is 120 degrees apart, and the fourth is 90 degrees apart.

As a precaution, in order to cover all the tracks and cylinders, the MFHs might be powered by either motor, actuator, solenoid or other means of action to move the RMFH slightly 1-5 millimeters in and out, either towards the center spindle or outward away from the spindle to cover and read/write all of the tracks and cylinders

### BRIEF DESCRIPTION OF THE DRAWINGS

FIG. 1 shows for a top view of the disc configuration.

FIG. 2 is a top view diagram of the head array in a staggered configuration, and in a zigzag configuration.

FIG. 3 is a diagram of the MFH rows of read/write heads and their location on a fixed row of arm aperture.

The following call out list of elements is used consistently herein.
25 Read/Write Head
31 Front Row Position
32 Middle Row Position
33 Rear Row Position
35 Multiple Fixed Head Array
41 Staggered Diagonal Configuration
42 Staggered Zigzag Configuration
44 Connection Wiring To An External Integrated Circuit
51 Actuator
65 Spindle
72 Housing
87 Motor
88 Disk

### DETAILED DESCRIPTION OF THE PREFERRED EMBODIMENT

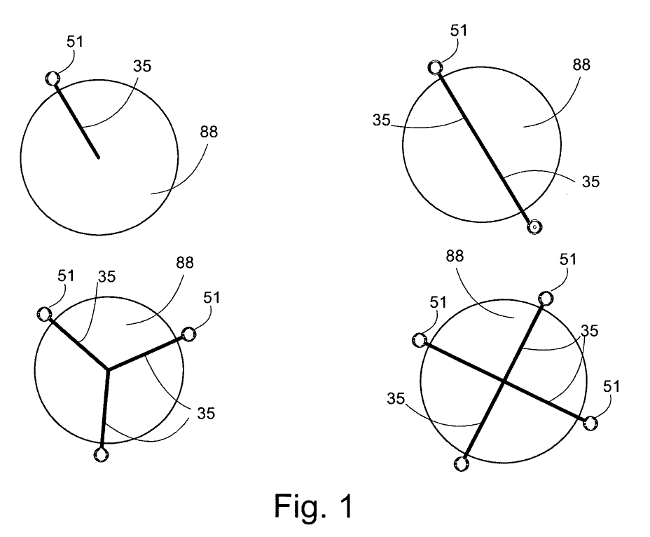

FIG. 1 shows that each platter has one or more multiple fixed head array 35. The heads 25 of the read/write heads are fixed relative to each other on the multiple fixed head array 35, however the entire multiple fixed head array 35 can be moved slightly by an actuator 51 to reach all physical locations. The first embodiment shown in the upper left has a single multiple fixed head array 35. The second embodiment shown in the upper right has a pair of multiple fixed head array 35 at 180° from each other. The third one embodiment shown in the lower left has three multiple fixed head array 35 at 120° from each other. The fourth embodiment shown in the lower right has four multiple fixed head array 35 at 90° from each other. The disc 88 in each configuration is of the same standard size. The number of disks can be multiple, and in a stacked configuration. The center of the disc has an axis of rotation. The discs may be numbered for ease of reference.

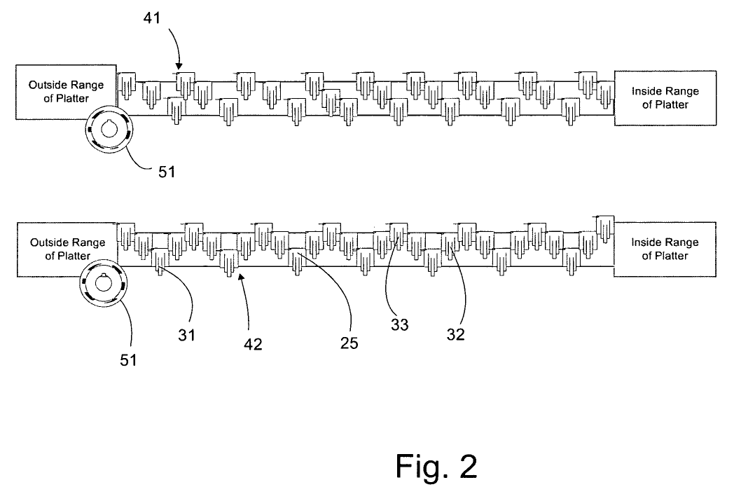

FIG. 2 shows multiple fixed heads staggered in staggered diagonal configuration 41 and also in staggered zigzag configuration 42. The rows are preferably three or more in number and cover all tracks and cylinders across sectors of the platter. The top view of the multiple platters on a hard drive show that an actuator 51 can be used to move the rows of the head slightly over a distance not more than one width of a head to reach all of the physical locations on the sector, track or cylinder to accomplish the read write process.

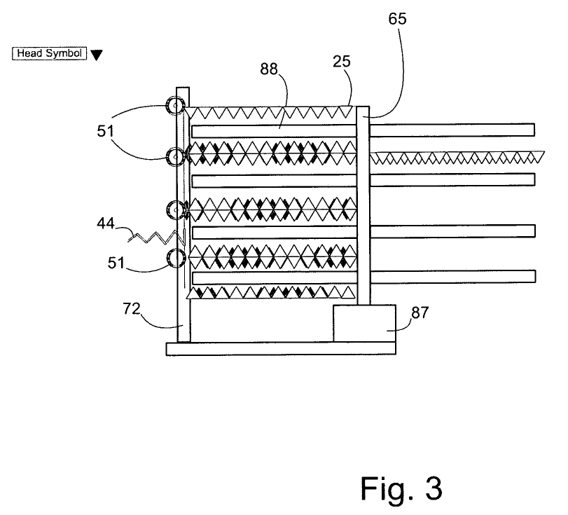

FIG. 3 shows a side view of multiple platters of a hard drive that has multiple fixed heads on a top platter. A center spindle 65 acts as an axis receiving the platters on the spindle. Typically, a motor 87 mounted on the housing 72 drives the spindle to a constant rotation. The housing 72 is shown in the diagram as a pole or rod like member which represents present typical hard drive enclosures having sidewalls, covers and shock absorption capabilities.

The platters rotate about the center spindle 65. The legend shows that the symbol for the head is diagrammatically expressed as a triangle where the tip of the triangle is the head, and the base of the triangle is the base of the head such that the triangle points toward the surface of the disk to be read or written. FIG. 3 also shows the two different sample variations of the conception as described above. The heads can be aligned in diagonal rows of three or more heads, or zig-zag rows of heads of three or more. The sample shows three heads per diagonal for illustration purposes. The purpose is so that ALL sectors and ALL Tracks/Cylinders on the platter, per platter, are covered and accessible for reads/write of data. Where required, a solenoid, motor or aperture can be used to move the entire rows of fixed heads IN or OUT towards or away from the center spindle to cover ALL the platter sectors and ALL Tracks/Cylinders on the platter.

Connection wiring 24 may connect the multiple fixed head array 35 to integrated circuitry, or circuit board for outputting the data to a personal computer. A housing 72 provides a mounting for the array of heads 35. Also, the heads can be arranged in an array where some of the heads are overlapping other heads as shown in the diagram. The actuator 51 mounted on the housing 72 may radially move the rows of heads relative to each other. This may cause some heads to clump together for improved data read and write speed. Alternatively, as seen on the right side of the second platter from the top, the heads can be evenly distributed so that an equal radial distance is seen between each head.

The set of three rows of the array of heads 35 can be doubled up so that there is a set of six rows of the array of heads 35 such as shown in FIG. 2 if the bottom three rows and the top three rows were used in conjunction with each other. The rows need not be equidistant and may spaced from each other, and then may be empty row architecture for utility or structural purposes.

The foregoing describes the preferred embodiments of the invention. Modifications may be made without departing from the spirit and scope of the invention as set forth in the following claims. The present invention is not limited to the embodiments described above, but encompasses any and all embodiments within the scope of the following claims.

1. A multiple head array hard drive comprising:
a. a multiple fixed head array which comprises multiple rows of read/write heads, wherein the read/write heads of a row are fixed relative to each other on the multiple fixed head array;
b. an actuator for radially moving the rows of the multiple fixed head array;
c. a disk that has data encoded on the disk, wherein the multiple fixed head array is positioned to read data over a surface of the disk, wherein the disc rotates relative to the multiple fixed head array.

2. The multiple head array hard drive of claim 1, wherein the multiple fixed head array is the first multiple fixed head array; and further comprising a second multiple fixed head array oriented at 180° from the first multiple fixed head array.

3. The multiple head array hard drive of claim 1, wherein the multiple fixed head array is the first multiple fixed head array; and further comprising a second multiple fixed head array oriented at 120° from the first multiple fixed head array; and further comprising a third multiple fixed head array oriented at 120° from the first multiple fixed head array.

4. The multiple head array hard drive of claim 1, wherein the multiple fixed head array is the first multiple fixed head array; and further comprising a second multiple fixed head array oriented at 90° from the first multiple fixed head array; and further comprising a third multiple fixed head array oriented at 90° from the first multiple fixed head array; and further comprising a fourth multiple fixed head array oriented at 90° from the first multiple fixed head array.

5. A multiple head array hard drive comprising:
a. a multiple fixed head array which comprises multiple rows of read/write heads, wherein the read/write heads of a row are fixed relative to each other on the multiple fixed head array;
b. a staggered pattern, wherein heads of the multiple fixed head array are arranged in a staggered pattern;
c. a disk that has data encoded on the disk, wherein the multiple fixed head array is positioned to read data over a surface of the disk, wherein the disc rotates relative to the multiple fixed head array.

6. The multiple head array hard drive of claim 5, wherein the staggered pattern is a zigzag pattern.

7. The multiple head array hard drive of claim 6, wherein the multiple fixed head array is the first multiple fixed head array; and further comprising a second multiple fixed head array oriented at 180° from the first multiple fixed head array.

8. The multiple head array hard drive of claim 6, wherein the multiple fixed head array is the first multiple fixed head array; and further comprising a second multiple fixed head array oriented at 120° from the first multiple fixed head array; and further comprising a third multiple fixed head array oriented at 120° from the first multiple fixed head array.

9. The multiple head array hard drive of claim 6, wherein the multiple fixed head array is the first multiple fixed head array; and further comprising a second multiple fixed head array oriented at 90° from the first multiple fixed head array; and further comprising a third multiple fixed head array oriented at 90° from the first multiple fixed head array; and further comprising a fourth multiple fixed head array oriented at 90° from the first multiple fixed head array.

10. The multiple head array hard drive of claim 5, wherein the staggered pattern is a diagonal pattern.

11. The multiple head array hard drive of claim 10, wherein the multiple fixed head array is the first multiple fixed head array; and further comprising a second multiple fixed head array oriented at 180° from the first multiple fixed head array.

12. The multiple head array hard drive of claim 10, wherein the multiple fixed head array is the first multiple fixed head array; and further comprising a second multiple fixed head array oriented at 120° from the first multiple fixed head array; and further comprising a third multiple fixed head array oriented at 120° from the first multiple fixed head array.

13. The multiple head array hard drive of claim 10, wherein the multiple fixed head array is the first multiple fixed head array; and further comprising a second multiple fixed head array oriented at 90° from the first multiple fixed head array; and further comprising a third multiple fixed head array oriented at 90° from the first multiple fixed head array; and further comprising a fourth multiple fixed head array oriented at 90° from the first multiple fixed head array.
